(19) United States
(12) Patent Application Publication
(10) Pub. No.: US 2002/0047865 A1
(43) Pub. Date: Apr. 25, 2002

(54) Process and apparatus for automatically producing program code

(76) Inventors: Bruno Bozionek, Borchen (DE); Joerg Littmann, Delbrueck (DE); Victor Lingscheid, Paderborn (DE)

Correspondence Address: BELL, BOYD & LLOYD, LLC, P. O. BOX 1135, CHICAGO, IL, 60690-1135, US

(21) Appl. No.: 09/934,663

(22) Filed: Aug. 22, 2001

(30) Foreign Application Priority Data
Aug. 22, 2000 (DE) 10041072.3

(51) Int. Cl. G06F 3/00; G06F 9/00

(52) U.S. Cl. 345/763

(57) ABSTRACT

A process for automatically producing software for a computer using components which exist in executable code depicts these components graphically as symbols, wherein an output interface can be connected to an input interface via a directional link. Program code is produced which produces an executable complete program on the basis of the selected directional links.

### BACKGROUND OF THE INVENTION

The present invention relates to a process for automatically producing program code and to a computer which is programmed such that this process is executable therein. The present invention also relates to a process which is used to enable persons who have no programming knowledge to use graphical symbols on a user interface to set up a telecommunications installation as specified by the user.

Program code—frequently referred to in literature as software—usually includes a number of program parts which have particular subtasks respectively associated with them. When developing software, the aim is to achieve the highest possible level of reusability for program parts which have already been programmed once. This allows subprograms which have already been tested and are certain to be largely free from error to be connected in a short time to form new programs. This significantly reduces the time required for developing application software, since a large part of the development time during software development is spent searching for errors and on a test phase. If a new user program includes only the combination of subprograms already tested, then the time saving is evident. In this context, the subprograms have often already been compiled and exist in machine-readable code. Such subprograms which can be compiled independently are referred to in a series of programming languages as modules. In the present case, the word “component” will be used as a more general term which does not relate to one specific programming language.

Software components, in turn, contain particular functions, procedures or methods which can be called using data as parameters. The choice of word depends on the specifically used programming language. The word which is for the most part usual for object-oriented languages—method—is used below. In this context, a component may have a single method or a number of methods.

To form an operational software program from such components which already exist, it is necessary to produce an intermediate code connecting the individual components to one another. In particular, the data formats of the data which are to be transferred from one component to another component and which are used to call a method need to be matched to one another, and code parts need to be written which call the methods. In this context, methods also may be called on the basis of conditions. In addition, code parts need to be written which are used to convert methods implemented in one component to other methods, which are intended to be able to be called in another component but are not implemented there.

This intermediate code is essentially produced manually. It is only known practice to generate function trunks for this intermediate code automatically. An example of such a component-based architecture is the COM/DCOM model from Microsoft.

In particular, in the case of telecommunications installations, it is necessary to match the control software individually to the requirements of the respective users. The control software for such telecommunications installations has a large number of program sections or components which are the same for control programs matched to different users. Matching can, therefore, be effected inexpensively and in a time-saving manner by linking such components.

A drawback of the prior art is that existing program code can continue to be used only when intermediate code is produced manually, and it is virtually impossible for a person who has no programming knowledge to produce software. Another drawback is that it is not possible for a person who has no programming knowledge to match the control of a modem complex telecommunications installation to the individual requirements of a user.

The present invention is directed to providing a process which can be used to produce software automatically from program code by linking existing components. It is further directed to providing a process which allows even laymen to match the control of a telecommunications installation on an individual basis.

### SUMMARY OF THE INVENTION

In the inventive process for automatically producing software, a symbol corresponding to a component having an input interface and an output interface is depicted in a graphical editor, for example using a computer, in a first step. The components existing in executable code each have an input interface and an output interface in which methods of the component, which can be called and implemented as part of the component, are defined in the input interface. Defined in the output interface are data formats for data of an event as the result of the implementation of a method or of an entire component, and methods which can be called in the component but are not executably contained in it.

In a second step, a selection option for directional linking of an output interface to an input interface is displayed. Next, a program code linking the components is produced on the basis of the links made. On the basis of events, for example, this program code calls methods which are defined in the input interface and transfers to the reception interface data of the event which are to be transferred to the method which is to be called, and/or program code is produced which converts the data formats of the callable method calls in the output interface into the data formats of the available method calls of the input interface.

In one advantageous embodiment of the present invention, the definition of the method calls which can be called via the links in the output interface is compared with the definition of available method calls of the input interface, and/or the data formats of an event of the output interface are compared with the data formats which are to be transferred to a method of the input interface. On the basis of the result of the comparison, the data formats of the method calls and of the data which are to be transferred thereto are matched if they are not compatible.

One beneficial feature of the inventive process is that a user requires no knowledge of the programming language in which the intermediate code is produced. Even a person who has no programming knowledge can easily produce links between appropriate components using graphically displayed selection options for links; for example, arrows. Code generation is automatic.

Advantageously, links from an event or a method of an output interface to a number of methods of input interfaces can be chosen, and a selection option for a condition for selecting the input interface of the link's program code which is to be formed can be offered. In this way, it is also possible to form “loops” by virtue of the input interface and the output interface belonging to the same component.

Advantageously, a component can be represented a number of times as a symbol, and the symbols for components can be arranged freely on a display area.

The program code can be produced in a “compiler language”, can be subsequently compiled and can be associated with the components to form an executable program. When a compiler and a link device required for this are used, fast code is produced which, by virtue of the fact that an interpreter is not required, requires little memory space because the complete program formed is executable independently.

Alternatively, the program code can be produced in an “interpreter language”. To this end, the known interpreter language XML (eXtensible Markup Language) advantageously can be used.

Beneficially, the program code is combined with the components as a dynamic link library and with an interpreter to form an executable complete program. Hence, advantageously, a compiler is not required.

By connecting one or more components on the basis of the above processes, new complete components can be formed and stored for subsequent applications. In this context, it is possible to stipulate both which parts of the output interfaces of the components used form the output interface of the complete component and which parts of the input interfaces of the components used form the input interface of the complete component.

The procedure described is advantageously used to produce the control software for a telecommunications installation. In this case, the process can be used on a control computer in the telecommunications installation itself.

According to the invention, a computer, in particular a control computer in a telecommunications installation, is programmed such that a previously described process can be executed thereon.

Additional features and advantages of the present invention are described in, and will be apparent from, the following Detailed Description of the Invention and the Figures.

### BRIEF DESCRIPTION OF THE FIGURES

FIG. 1 shows an illustration of two components as symbols with a link between an output interface and an input interface.

FIG. 2 shows an illustrative tabular comparison of parameters which are to be matched.

FIG. 2a shows the assignment of the parameters from FIG. 2 in declarations of associated methods.

FIG. 3 shows a printout of the intermediate code produced for a link between two methods in a compiler language.

FIG. 4 shows a printout of the intermediate code produced for a link between two methods in an interpreter language.

FIG. 5 shows two links from an output interface to two different input interfaces.

FIG. 6 shows the inventive graphical representation of a complete program with the links formed.

FIG. 7 shows a link from an output interface to three input interfaces.

FIG. 8 shows a conditional link to two input interfaces.

FIG. 9 shows a loop formed using a conditional link.

FIG. 10 shows two links to the same input interface.

FIG. 11 shows a component newly compiled from existing components by the inventive process in an exemplary illustration of a graphical editor.

### DETAILED DESCRIPTION OF THE INVENTION

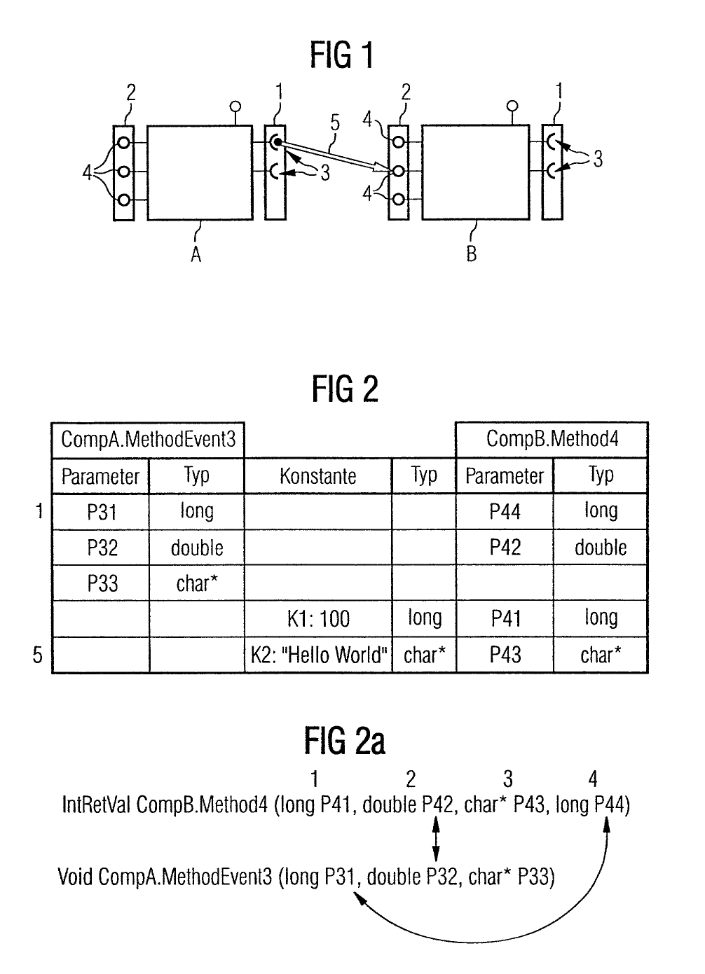

FIG. 1 shows a schematic illustration of two components A, B with a link 5 connecting the components A, B. The component A and the component B each have an output interface 1 and an input interface 2, which are indicated by a box in the present exemplary embodiment. Defined in the output interfaces 1 are events 3 which may occur as the result of the implementation of a method of the component A, B, and methods 3 which are intended to be able to be called in the component A, B but whose code is implemented not in the method itself but elsewhere instead. In the figures, these events and methods are respectively denoted in summarized fashion by a reference symbol; in this case (FIG. 1), by the reference symbol 3. Defined in the input interfaces 2 are methods 4 of the components A, B, which can be called as part of the components. These methods 4 are implemented in the components A, B.

In the inventive process illustrated here by way of example, the components A, B are depicted in a graphical editor, as shown in FIG. 1. A user can now select a directional link 5 between an output interface 1 and an input interface 2 which is then, likewise, displayed graphically. In the present exemplary embodiment, the directional link 5 is represented by a double arrow. This link 5 is used by the user upon a particular event 3, which is defined in the output interface 1, to call a method 4 of the input interface 2. Alternatively, a method 3 which is intended to be able to be called in a component A, B—in this case the component A—can be defined by virtue of the intermediate code defining the method of the output interface 1 via a method 4 of the input interface 2. As such, in cases in which a method 3 is called in the component A, the intermediate code calls the appropriate chosen method 4 of the input interface 2 of the component B. In this context, the intermediate code converts the appropriate calls into one another. To this end, however, the data formats of the data transferred when the methods are called need to be matched to one another.

FIG. 2 shows a table with an illustrative comparison of associated parameters and parameters which need to be matched to one another for methods CompA.MethodEvent3, CompB.Method4 of the components A, B and, in addition, in the center column, constants which need to be complemented. As an example, the data formats of the known programming language “C” are chosen. For reference purposes, row numbering in steps of five is printed on the left. The two parameters in the first and second rows can, accordingly, be mapped easily onto one another because the two methods CompA.MethodEvent3, CompB.Method4 have identical variable definitions. A variable P31 in “long” format in the first row has a corresponding variable P44 in “long” format as parameter. Accordingly, a variable P32 in “double” format has an opposing variable P42 in “double” format in the second row.

In the third row, the method CompA.MethodEvent3 of the component A has a “string variable” which, in accordance with the conventions of the programming language “C”, is defined as a pointer to the first location in a memory area allocated for this purpose. This location stores the first letter in the string. The string is deemed to be validly stipulated up to a “termination symbol” ‘\’ in the memory area. The method to be called CompB.Method4 of the component B has no corresponding parameter. To this extent, conversion need not take place in this case.

In the fourth row, the constant “100” in “long” format in the center column and a variable P41 in the same format confront one another. Similarly, in the fifth row, a constant string and a string variable P43 confront one another. Both constants need to be complemented, since they do not occur in the method CompA.MethodEvent 3 of the component A. The constants are thus transferred as parameters to the method CompB.Method4 of the component B.

FIG. 2a shows a schematic illustration of the assignment of the parameters from FIG. 2 in declarations of the associated methods CompA.MethodEvent3, CompB.Method4. The top row of the illustration corresponds to the program code used to declare the method (CompB.Method4) of the component B. In the bottom row, a method CompA.MethodEvent3 is declared which is intended to be available in the component A. At the top, the numerals 1 to 4 stipulate the order of the parameters in the declarations.

The parameters are assigned and matched as explained in FIG. 2. It is now also necessary to ensure the order of the parameters and, hence, the correct assignment. The first parameter of the method CompA.MethodEvent3 of the component A is the variable P31, which corresponds to the variable P44 of the method CompB.Method4 of the component B. The variable P31 is therefore transferred as fourth parameter to the method CompB.Method4 of the component B. The correspondence is clarified by an arrow. The second parameter of the method CompA.MethodEvent3 of the component A is the variable P32, which corresponds to the variable P42 of the method CompB.Method4 of the component B and is transferred thereto, likewise, as second parameter. In this case, too, the correspondence is clarified by an arrow in the FIG. 2a. The third parameter of the method CompA.MethodEvent3 of the component A is not transferred because it has no correspondence. The missing parameters as variables P41 and P43 of the method CompB.Method4 of the component B are, as described with reference to FIG. 2, replaced by constants and are transferred to the method CompB.Method4 of the component B as first parameter and third parameter.

The data also can be transferred to methods as parameters without any explicit conversion if their formats are strictly regulated. In this case, the number and data type of all formats for events and methods defined in an output interface are such that they can be transferred directly to methods of an input interface as parameters. This is particularly possible for specific applications such as voice processing programs. These can be provided with a fixed association between the parameters without the possibility of influencing when links are produced. In this case, the methods have either no variables or global variables as input parameters.

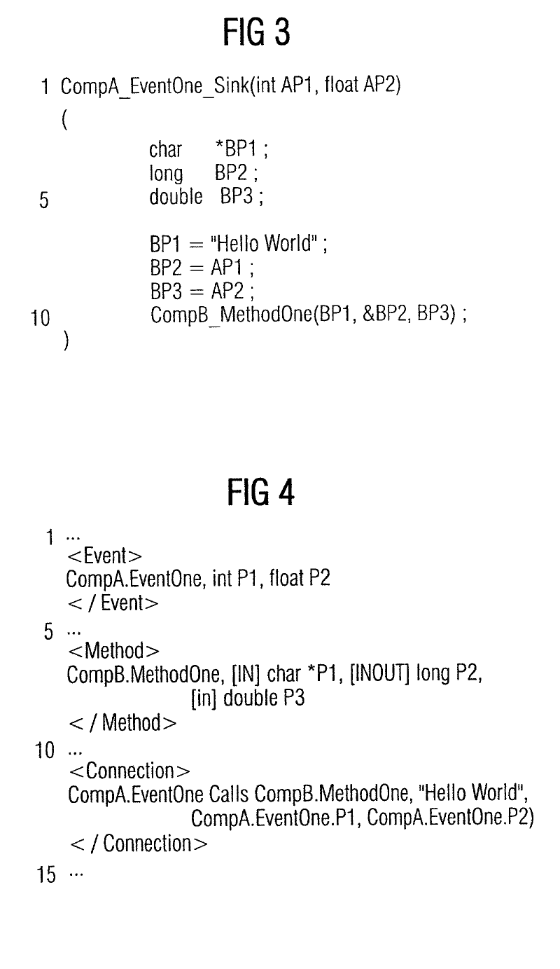

FIG. 3 shows, as source code, an example of an intermediate code produced in a compiler language. For reference purposes, row numbering in steps of five is additionally printed on the left. The programming language used by way of example is “C”. What is printed here is the automatically produced intermediate code which can be used to convert a method which is defined in an output interface and is not implemented in the appropriate component into a method in an input interface of a component. In a component A, a method CompA_EventOne_Sink&Ovalhollow; is demanded which is not implemented there, however. In an input interface of a component B, a method CompB_MethodOne&Ovalhollow; is available. FIG. 3 shows the method declaration for the method CompA_EventOne_Sink&Ovalhollow;. For this purpose, a further string variable BP1, which is demanded in the parameters of the method CompB_MethodOne&Ovalhollow;, needs to be defined in row 3 and assigned in row 6. In addition, the integer variable BP3 is transferred to the method CompB_MethodOne&Ovalhollow; as pointer.

The source code produced in this way now can be compiled by a converter, which is frequently referred to in Literature as a “Compiler”, and can be connected to the components using an associator, which is frequently referred to in literature as a ‘Linker’—to form an executable program. Depending on the type of link device used, the code of the components originally may have been written in different programming languages. The code produced is very fast and its execution speed comes close to manually written intermediate code. A drawback, however, is that a compiler and a link device are required for generating the executable code, and appropriate licenses need to be obtained for these.

FIG. 4 shows, as source code, an example of intermediate code produced in an “interpreter language”. For reference purposes, row numbering in steps of five is additionally printed on the left. The language in this case is the known interpreter language “eXtensible Markup Language” (XML). In this case, too, a method which is defined in an output interface and is not implemented in the corresponding component is converted into a method in an input interface of another component. The methods are referred to as CompA_EventOne in row 3 and CompB_MethodOne in row 7. The method CompA-EventOne calls the method CompB_MethodOne in row 12, with a string constant “Hello World” being inserted in order to satisfy the parameter declaration of the method CompB_MethodOne.

The source code produced in this way now can be connected using an interpreter to form an executable program. Only at the execution time of the program are the command lines lexicographically and syntactically analyzed and implemented by the interpreter. In this case, the methods already provided in machine code are called within the context of a dynamic link library. Advantageously, a few telecommunications installations provide “application composers”, which contain an interpreter. The compiler and the link device can be obviated, and no additional license costs arise for these programs. A drawback, however, is the much lower execution speed of the programs formed in this way. This is not very significant for functions having no real-time relevance, however.

FIG. 5 shows an example of two links 6 from two events or methods 7 of an output interface 8 of a component C to two methods 9 of two input interfaces 10 of two components D and E. The latter are independent of one another; the decision regarding which link follows in the program flow is made in the component C, depending on which event occurs.

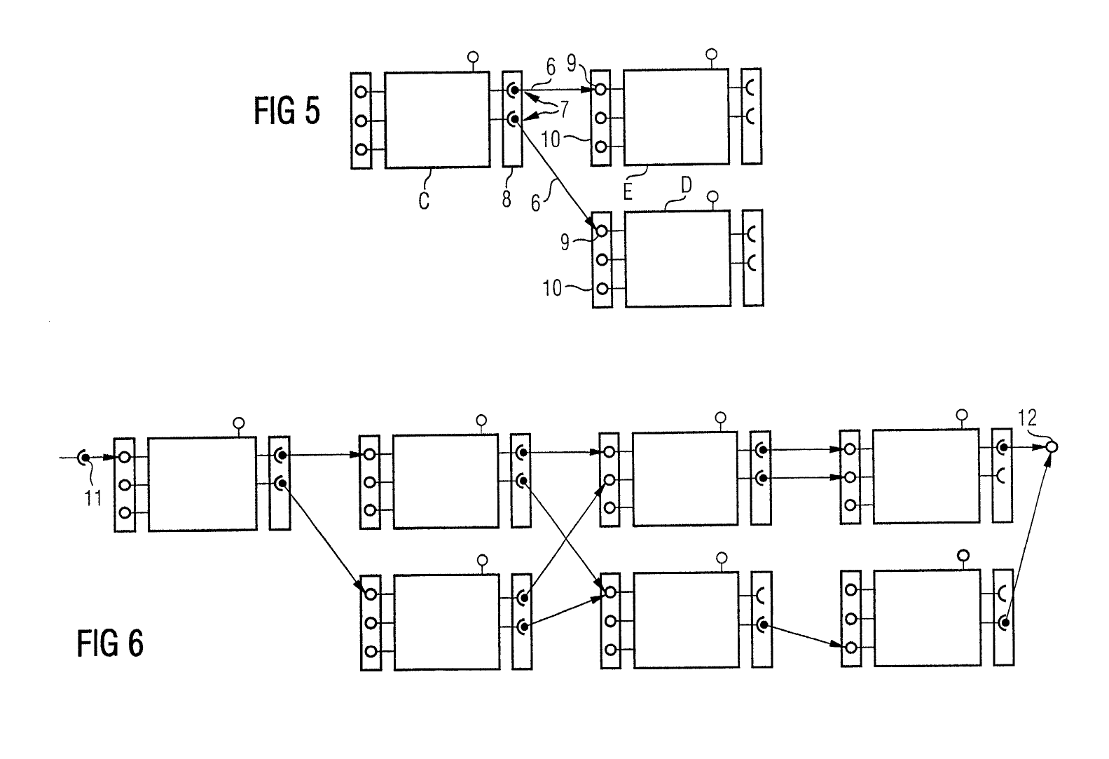

FIG. 6 shows the graphical illustration of 7 symbols, corresponding to components, having links which are defined between these components by a user, a start event 11 and a termination method 12. In this context, a component also can be denoted by a number of symbols and can, thus, appear at a number of locations in the program flowchart. For the sake of clarity, further reference symbols have been omitted. The symbol representation of the components corresponds to that in the previous figures. The representation corresponds to a full program produced using the inventive process. The program produced is produced in an application context. The start event allows the program to be called. In the case of a control program for a telecommunications installation, this is “switching on”, for example. Similarly, a defined termination call should be provided for correct ending of the program. In the case of a control program for a telecommunications installation, this termination method would, by way of example, be “shutting down” for the purposes of switching off.

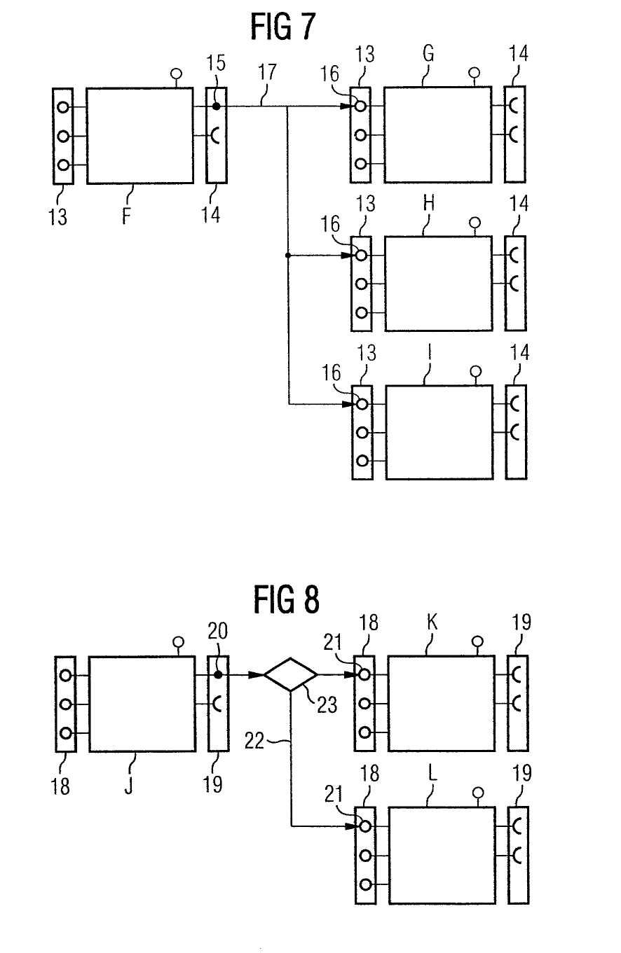

FIG. 7 shows four components F,G,H,I, each having an input interface 13 and an output interface 14. From an event 15 of the output interface 14 of the component F, there is a link 17 to three different methods 16 of the input interfaces 13 of the components G,H,I. FIG. 7 shows an example of a link 17 routed from an event 15 to a number of methods 15 in various input interfaces 13. In this case, the intermediate code needs to define an order of implementation.

FIG. 8 shows three components J,K,L, each having an input interface 18 and an output interface 19. From an event 20 of the output interface 19 of the component J, there is a link 22 to two different methods 21 of the input interfaces 18 of the components K,L. FIG. 8 shows an example of a link 22 which, under the control of a condition query 23 of the intermediate code, is routed from an event 20 to two methods 21.

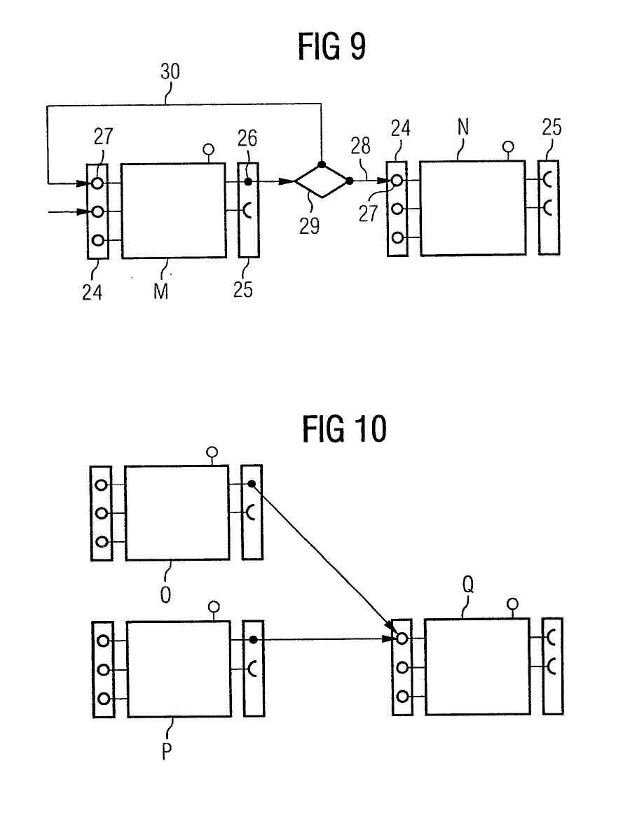

FIG. 9 shows two components M,N, each having an input interface 24 and an output interface 25. From an event 26 of the output interface 25 of the component M, there is a link 28 to two different methods 27 of the input interfaces 24 of the components M,N. FIG. 9 shows an example of a link 28 which, under the control of a condition query 29 of the intermediate code, forms a loop. The graphical representation allows a user to define a loop 30 by virtue of a branch in the conditional link 28 being returned to the input interface 24 of the component M.

FIG. 10 shows three components O,P,Q. The parts of the graphical representation which already have been explained previously in the figures are not provided with reference symbols. In this case, two links 31 point to the same method of the component Q. These are two single links calling the same method.

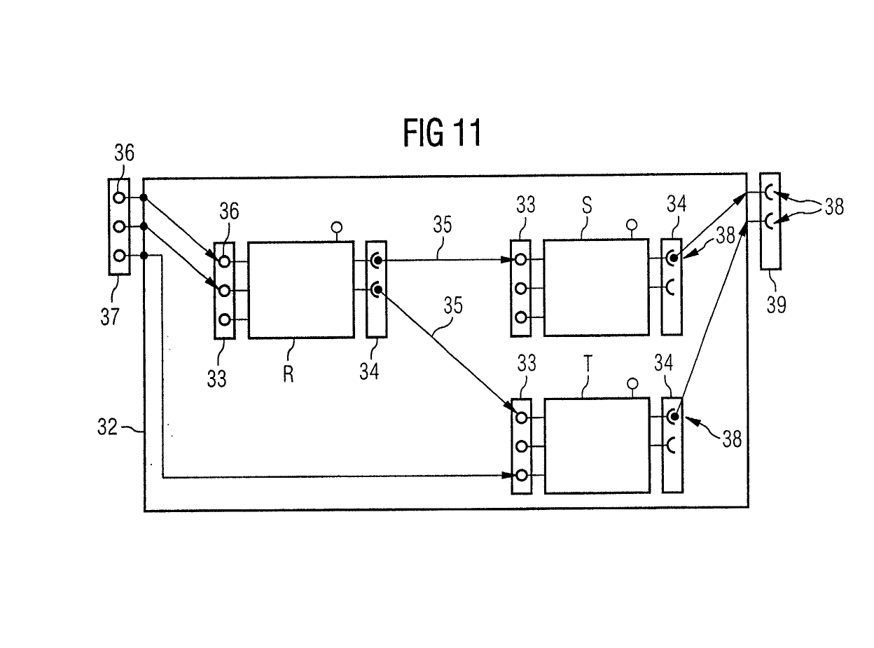

FIG. 11 shows an advantageous refinement of the process which allows new components to be formed. In this context, components are combined in accordance with the inventive process to form a new complete component 32. In the present example, the components R, S, T are combined to form the complete component 32. The components R,S,T have input interfaces 33 and output interfaces 34. Internal links 35 allow the user to stipulate the functionality of the complete component 32. In addition, it is possible to stipulate, graphically, which methods 36 of the input interfaces 33 are available in a complete input interface 37. Similarly, it is possible to stipulate, graphically, which methods and events which have been combined under the common reference symbol 38 are available to the output interface 34 in a complete output interface 39. The complete component formed thereby has the same properties as any other component.

The process described allows even persons with no programming knowledge to produce a program. This is possible particularly for control programs for telecommunications installations, for which it is easy to foresee the required components.

Although the present invention has been described with reference to specific embodiments, those of skill in the art will recognize that changes may be made thereto without departing from the spirit and scope of the invention as set forth in the hereafter appended claims.

1. A process for automatically producing software for a computer using a plurality of components which exist in executable code, comprising the steps of:
providing an input interface for each of the components in which respective methods of each of the components are defined which can be called and implemented as part of the respective component;
providing an output interface for each of the components in which respective data formats are defined for data of a respective event as a result of implementation of one of a respective method and a respective component, and in which respective further methods are defined which can be called in the respective component but are not executably contained in the respective component;
depicting, in a graphical editor, a symbol corresponding to one of the components having a respective input interface and a respective output interface;
offering a selection option for directional linking of an output interface of one of the components to an input interface of another of the components; and
producing a program code linking the one component to the another component based on links made.

2. A process for automatically producing software for a computer as claimed in claim 1, further comprising at least one of the following steps:
calling a respective method, via the program code and based on a respective event, which is defined in the input interface of the another component, and transferring, via the program code, the data of the respective event to the respective method which is called, the data being expected by the method which is to be called; and
converting, via the program code, the respective data formats of the callable methods in the output interface of the one component into the respective data formats of the available methods of the input interface of the another component, and converting the methods into one another.

3. A process for automatically producing software for a computer as claimed in claim 1, further comprising at least one of the following steps:
comparing the definition of the method to be called in the output interface of the one component with the definition of available methods of the input interface of the another component; and
comparing the respective data formats of an event of the output interface of the one component with the respective data formats to be transferred to a method of the input interface of the another component.

4. A process for automatically producing software for a computer as claimed in claim 3, further comprising at least one of the following steps:
matching the data formats of the callable methods in the output interface of the one component to the data formats of the available methods of the input interface of the another component; and
matching the data formats of the event of the output interface of the component to the data formats to be transferred to the method of the input interface of the another component if they are not compatible.

5. A process for automatically producing software for a computer as claimed in claim 1, wherein a link from one of an event and a method of the output interface of the one component to a plurality of methods of the input interface of the another component can be chosen.

6. A process for automatically producing software for a computer as claimed in claim 5, further comprising the step of:
determining a condition for selecting the methods of the input interface of the another component for the link.

7. A process for automatically producing software for a computer as claimed in claim 1, wherein an input interface and an output interface belong to the same component.

8. A process for automatically producing software for a computer as claimed in claim 1, wherein a plurality of links can be made for a method of an input interface.

9. A process for automatically producing software for a computer as claimed in claim 1, wherein a component can be represented a plurality of times as a symbol.

10. A process for automatically producing software for a computer as claimed in claim 1, wherein the symbols for components can be arranged freely on a display area of the graphical editor.

11. A process for automatically producing software for a computer as claimed in claim 1, further comprising the steps of:
producing and compiling the program code in a compiler language; and
associating the produced and compiled program code with the components to form an executable program.

12. A process for automatically producing software for a computer as claimed in claim 1, wherein the program code is produced in an interpretator language.

13. A process for automatically producing software for a computer as claimed in claim 12, wherein the interpretator language is XML.

14. A process for automatically producing software for a computer as claimed in claim 12, further comprising the steps of:
combining the program code with the components as a dynamic link library; and
combining the program code with an interpretator to form an executable complete program.

15. A process for automatically producing software for a computer as claimed in claim 1, further comprising the step of:
connecting at least two of the components to form a new complete component, it being possible to stipulate which methods and events of the output interfaces of the at least two components used form the output interface of the complete component, and which methods of the input interfaces of the at least two components used form the input interface of the complete component.

16. A process for automatically producing software for a computer as claimed in claim 1, wherein the software is controlled software for a telecommunications installation.

17. A process for automatically producing software for a computer as claimed in claim 16, wherein the telecommunications installation is a telephone exchange.

18. A process for automatically producing software for a computer as claimed in claim 16, wherein the control software is on a control computer in the telecommunications installation.

19. A computer for automatically producing software using a plurality of components which exist in executable code, comprising:
an input interface for each of the components in which respective methods of each of the components are defined which can be called and implemented as part of the respective component;
an output interface for each of the components in which respective data formats are defined for data of a respective event as a result of implementation of one of a respective method and a respective component, and in which respective further methods are defined which can be called in the respective component but are not executably contained in the respective component; and
a graphical editor, wherein a symbol corresponding to one of the components having a respective input interface and a respective output interface is depicted;
wherein a selection option for directional linking of an output interface of one of the components to an input interface of another of the components is offered, and a program code linking the one component to the another component is produced based on links made.
